(19) United States
(12) Patent Application Publication
(10) Pub. No.: US 2004/0043105 A1
(43) Pub. Date: Mar. 4, 2004

(54) Glycine-enriched vegetable compound feed for a layer chicken

(76) Inventors: Hiroshi Miura, Tochigi-ken (JP); Kazuya Iwasaki, Kagoshima-ken (JP); Tamotsu Suzuki, Tochigi-ken (JP)

Correspondence Address: FLYNN THIEL BOUTELL & TANIS, P.C., 2026 RAMBLING ROAD, KALAMAZOO, MI, 49008-1699, US

(21) Appl. No.: 10/228,448

(22) Filed: Aug. 27, 2002

(51) Int. Cl. A01K 1/00

(52) U.S. Cl. 426/2

(57) ABSTRACT

There is disclosed herein a glycine-enriched vegetable compound feed for a layer chicken which has effects to mitigate hot stress and to suppress the morality caused by hot stress in summer season.

According to the present invention, there is provided a glycine enriched vegetable compound feed for a layer chicken which comprises incorporated glycine into a vegetable compound feed in the range of 0.05-0.5% by weight based on the feed.

The present invention relates to a vegetable compound feed composition for a layer chicken which has an effect to mitigate hot stress and to a process for feeding a layer chicken.

### PRIOR ART

In the summer season layer chickens are susceptive to a bad influence. For example, egg production yield is reduced due to hot stress and some ones die due to heatstroke, thus a serious influence is affected on the productivity.

Recently, there has been increased the fear to the safety of the animal feed for the possibility of the increase in the food poisoning by Salmonella which gets into the inside of egg due to the decline in the quality of the animal protein raw material and due to unsanitary treatment done during its processing step, and correspondingly consumption of the value added eggs has been expanded. Under these circumstances, the tendency is increasing to shift the feed for a layer chicken from an animal compound feed to a complete vegetable compound feed which contains no animal protein raw material.

In this connection, there has been brought out a problem that the mortality occurrence frequency for layer chickens fed with a complete vegetable compound feed (hereinafter, referred to as “the complete vegetable group” caused by thermal stress in the summer season is relatively higher as compared with layer chickens fed with an animal protein compound feed (hereinafter, referred to as “the animal protein groups”).

As illustrated in Experimental Example described later, the complete vegetable compound feed used in the experiment meets the nutrition requirement for a layer chicken according to Japanese Feeding Standard like an animal protein compound feed (see table 1 in Experimental Example) and there is no nutritional difference between these two feeds. Nevertheless, there has been recognized a significant difference between two groups of chickens fed with animal protein compound feed and the complete vegetable compound feed in their stress susceptibility under high temperature exposure and thermal (hot) environment, especially in the change in their body temperature. More specifically, the crest temperature of the complete vegetable group is higher over the entire range of temperature tested than that of the animal protein group (see FIG. 1), and the average crest temperature of the complete vegetable group is 0.35° C. higher than that of the animal protein group. This suggests that the complete vegetable group has higher rate in the mortality caused by hot stress in the summer season as compared with the animal protein group.

### SUMMARY OF THE INVENTION

An object of the present invention is to provide a vegetable compound feed composition for a layer chicken for suppressing or preventing harmful influences including the morality caused by hot stress as seen in the complete vegetable group in the summer season thereby their resistance power to hot stress is increased to equal level to or slightly less level than that in the animal protein group, namely an effect to mitigate hot stress may be exerted.

Another object of the present invention is to provide a method for feeding a layer chicken which comprises feeding a layer chicken with said vegetable compound feed compound in summer season.

The present inventors has attempted to make two kinds of feed formulations with animal and vegetable raw materials, one feed formulation consisting essentially of vegetable raw material (complete vegetable compound feed) and the other feed formulation being an animal protein compound feed, there being no appreciable difference in the crude protein content, other ingredient content and the metabolizable energy value between these two feeds. The results of inspection of these two feeds for the amino acid composition are shown in table 1 in Experimental Example as described later. Table 1 reveals that there is an appreciable difference in the glycine content between these two feeds and that the glycine content in the complete vegetable compound feed is about 0.3% by weight less than that in the animal protein compound feed. Glycine is a kind of glycogenic amino acid and relates closely to nitrogen metabolism.

The present inventors have found that when glycine is supplemented to a complete vegetable feed for a layer chicken for the purpose of increasing glycine intake, effect of mitigating hot stress be achieved. The present invention was completed based on this finding.

That is, the present invention is a glycine-enriched vegetable compound feed for a layer chicken which comprises incorporated glycine into a vegetable compound feed in the range of 0.05-0.5% by weight based on the feed.

Also, the present invention relates to a method for feeding a layer chicken which comprises feeding a latter chicken with said glycine-enriched vegetable compound feed compound in summer season thereby causing an effect to mitigate hot stress.

### BRIEF EXPLANATION OF THE DRAWINGS

FIG. 1 graphically illustrates the changes in the crest temperature for the complete vegetable group and the animal protein group respectively exposed to hot stress.

FIG. 2 graphically illustrates the changes in the crest temperature for the complete vegetable group, layer chickens fed with glycine-added complete vegetable compound feed (hereinafter, referred to as “the glycine-addition group”) and the animal protein group respectively exposed to hot stress.

FIG. 3 graphically illustrates the changes in the crest temperature for the complete vegetable group, the glycine-addition group and the animal protein group respectively exposed to hot stress.

FIG. 4 graphically illustrates the mortality occurrence status for the complete vegetable group, the glycine-addition group and the animal protein group respectively exposed to hot stress.

### DATAILED EXPLANATION OF THE PREFERRED EMBODIMENTS

The feed for a layer chicken in the present invention is one wherein all the protein source and metabolic energy source are limited to vegetable raw materials and glycine contained in the feed is enriched to the range of 0.05-0.5% by weight higher than originally contained in the feed.

The other components of the feed may be the same as the conventional feed for layer chicken and include a protein source, an energy source, a calcium source, a magnesium source, a phosphorus source, vitamins, minerals and the like and may be blended in such amount as to meet the requirements of NCR and Japanese Feeding Standard. As a vegetable raw material, there may be selected from the among cereals such as corn, wheat, barley and milo; bran, wheat bran, rice bran, defatted rice bran, soybean meal, rapeseed meal, coconut meal, and linseed meal. It is necessary to incorporate a calcium source, a magnesium source, a phosphorus source, vitamins, minerals and the like into the feed like the conventional feed. The feed contains 15.5-19.5% by weight of crude protein (CP), 3.2-4.5% by weight of calcium, 0.21-0.28% by weight of magnesium, 0.35-0.45% by weight of non-phytin phosphorus (e.g. tricalcium phosphate, dicalcium phosphate) and about 2800-2950 kcal/kg of metabolizable energy (ME).

When the feed was prepared using the vegetable raw materials as above-stated which meets the nutrition requirement of Japanese Feeding Standard, then the content of glycine in the feed is about 0.75% by weight. According to the present invention, the content of glycine in the feed is enriched to the range of 0.8-1.2% by weight by adding glycine to the feed. It is not necessary to adapt the content of glycine in the feed to that in the animal protein compound feed. Even when it is less than the animal protein compound feed, the effect of mitigating hot stress may be exerted. Glycine is added to the vegetable compound feed in 0.05-0.5% by weight, preferably 0.1-0.2% by weight based on the feed and mixed together. When the amount added of glycine is less than 0.05% byr weight, the effect to mitigate hot stress is not sufficient. On the other hand, when it exceeds 0.5% by weight, the effect is sufficient but the extent of the effect is not so much relative to the amount added of glycine and it is not advantageous from the economical aspect.

Although the mechanism regarding the effect of mitigating hot stress by the glycine-enriched vegetable compound feed has not been identified yet, it is considered to be due to the increased amount in glycine requirement during the uric acid nitrogen excretion in the complete vegetable group.

By feeding the layer chicken with the glycine-enriched vegetable compound feed in the summer season, there may be achieved the effect of mitigating hot stress that is comparable to that achieved by feeding the layer chicken with the animal protein compound feed.

The following Examples illustrate the present invention more specifically but the present invention is not restricted thereto.

### EXAMPLES

### Experimental Example

The Exposure Test of the Complete Vegetable and Animal Protein Groups

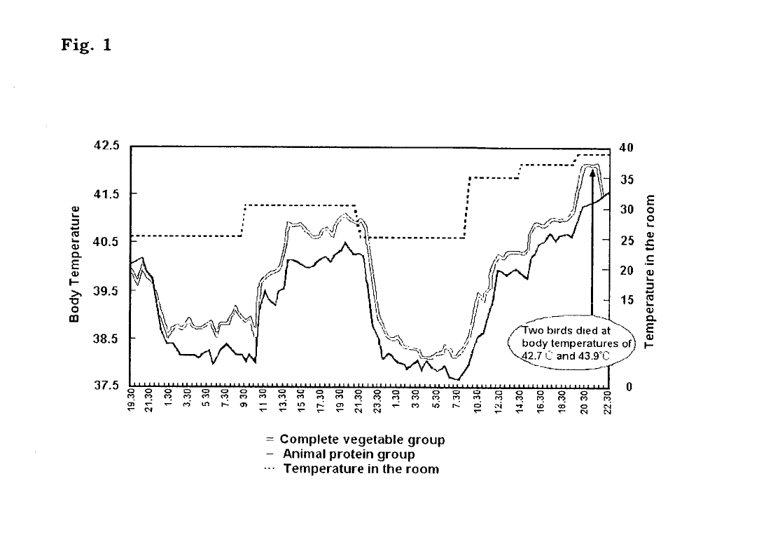

Two groups each of five JLA chickens of 440 days old was employed in the test and reared in an environment control room for 14 days. As the environment setup, 25° C.—12 hours and 30° C.—12 hours cycle was operated and then the temperature was gradually raised for the subsequent 3 days as shown in FIG. 1. In this case a temperature sensor was set to the crest for the purpose of confirming the change in the body temperature. In order to remove the deviation of data by stress reaction of chickens exposed to the high temperature, 4 days after the start of the test was placed as the high temperature adaptation period. During the subsequent 2 days sampling was conducted. Three samplings in the total were done to evaluate the changes in the amount of feed intake and the amount of water consumed.

The details of the test items are shown below.

| | |
|---|---|
| Test setup: | 25° C.—12 hours |
| | 30° C.—12 hours (8:00˜20:00) |
| | Light was provided for 16 hours (4:00˜20:00). |

Test place: the environment control room located in Research Laboratory, Itochu Feed Mills Co., Ltd.

Test chicken: there was used each group of five JLA chickens of 440 days old at the start of the test and laying continuously an egg for 5 days before the test.

Feed:

An animal protein compound feed “Itochu YL18” (a trade name, a product manufactured on July, 1999 by Itochu Feed Mills Co., Ltd.).

A complete vegetable compound feed “Itochu Layer 18SU” (a trade name, a product manufactured on July, 1999 by Itochu Feed Mills Co., Ltd.).

Both the feeds were ones which meet the requirement for the following ingredients.

TABLE 1

| Calculated Value | Complete | | Animal | |
|---|---|---|---|---|
| For Component | Vegetable Feed | | Protein Feed | |
| ME | 2920 | kcal/kg | 2950 | kcal/kg |
| CP | 19.3% | | 19.3% | |
| Met | 0.42% | | 0.42% | |
| Ca | 3.95% | | 3.95% | |
| Non-phytin | 0.43% | | 0.45% | |
| phosphorus | | | | |

The test results are shown in Table 2 and FIG. 1.

TABLE 2

| | | Conventional | Conventional |
|---|---|---|---|
| | | Example 1 | Example 2 |
| | | (Animal | (Complete |
| Feeding Result | | Protein Group) | Vegetable Group) |
| Feed Intake | \mathring{1} | 94.6 ± 8.5 | 100.5 ± 9.4 |
| (g/day/bird) | \mathring{2} | 98.1 ± 4.6 | 103.6 ± 5.2 |
| | \mathring{3} | 102.7 ± 10.8 | 103.1 ± 5.8 |
| | Average | 98.5 ± 6.8 | 102.4 ± 2.6 |
| Water consumed | \mathring{1} | 335.5 ± 127.5 | 356.3 ± 24.1 |
| (ml/day/bird) | \mathring{2} | 313.6 ± 65.2 | 335.9 ± 37.9 |
| | \mathring{3} | 295.1 ± 61.4 | 327.6 ± 46.2 |
| | Average | 314.7 ± 83.4 | 339.9 ± 24.5 |

The relationship between the crest temperature (y) and the rectal temperature (x) is represented by the following regression equation:

y=1.3x−15.8

When the rectal temperature is estimated from the crest temperature in the death, 42.7° C. of the crest temperature gives 45° C. of the rectal temperature. Similarly, 43.9° C. of the crest temperature gives 45.9° C. of the rectal temperature. These values are identical with the rectal temperature in the death as generally known for broiler chicken (W. T. Zhou et al; Avian Journal of Animal Science 1977 Vol. 10, No. 6, P. 652-656). The amount of feed intake in the complete vegetable group is about 4 g/day/bird higher than that in the animal protein group. The amount of ME intake in the complete vegetable group was 302.1 Kcal/day/bird while that in the animal protein group was 287.6 Kcal/day/bird. Also, the amount of water consumed in the complete vegetable group is 25.2 ml higher than that in the animal protein group.

Although the average crest temperature of each group of 5 birds during the test period was up and down depending on the environmental temperature, the crest temperature of the complete vegetable group is always 0.35° C., higher than that of the animal protein group. Among the complete vegetable group, two birds died due to heat stress and their crest temperatures in the death were 43.9° C. and 42.7° C. Contrary thereto, there was no occurrence of the mortality in the animal protein group.

It is considered from the results of this test that the quantity accumulated of body heat in the complete vegetable group under the high temperature environment is larger than that in the animal protein group and correspondingly the body temperature increased.

The respective amino acid compositions in the animal protein compound feed and the complete vegetable compound feed are shown in table 3. It is recognized from table 3 that there is a significant difference in the glycine content between these two feeds.

TABLE 3

| | Animal Protein | Complete Vegetable |
|---|---|---|
| Component | Compound Feed | Compound Feed |
| CP (%) | 19.3 | 19.3 |
| Met (%) | 0.42 | 0.43 |
| M + C (%) | 0.77 | 0.81 |
| Lys (%) | 0.88 | 0.85 |
| Arg (%) | 1.179 | 1.113 |
| Trp (%) | 0.206 | 0.214 |
| Thr (%) | 0.720 | 0.730 |
| Leu (%) | 1.988 | 2.189 |
| Ile (%) | 0.770 | 0.819 |
| Gly (%) | 1.079 | 0.759 |
| Phe (%) | 0.938 | 1.013 |
| Thy (%) | 0.676 | 0.743 |
| His (%) | 0.479 | 0.492 |
| Val (%) | 0.911 | 0.927 |
| Ser (%) | 0.895 | 0.924 |

### Examples 1 and 2

Test method: Dekalb TX 35 species five layer chickens (260 days old) were used in each group of two replicates and reared in an environment control room for 17 days. As the environment temperature, 27° C.—12 hours/35° C.—12 hours cycle was operated by thermostatic control from the start of test and 3 days after the start of the test were placed as high temperature-adaptation period for removing the deviation of data by stress reaction of chickens exposed to high temperature, and during the subsequent 2 days one sampling was conducted. Two samplings in the total were made during 2 weeks to evaluate change in the amount of feed intake and in the amount of water consumed.

The detail of the test items is shown below. In this test, multi-channel thermometer “Datalogger R7326B” (a product of Advantest Company) was introduced and the crest temperatures of 40 birds were simultaneously measured to evaluate the change in the temperature of the bird exposed to high temperature.

| | |
|---|---|
| Test setup: | 27° C.—12 hours |
| | 35° C.—12 hours (8:00˜20:00) |
| | Light was provided for 16 hours (4:00˜20:00). |

Test place: The environment control room (B and C rooms) located in Research Laboratory, Itochu Feed Mills Co., Ltd.

Test chicken: Dekalb TX 35 species five layer chickens of 260 days old at the start of the test and of having laid continuously an egg for 5 days before test were used in each group of two replicates.

Feed:

Animal protein compound feed: “Itochu YL18” (a product manufactured on July, 1999 by Moji Plant of Itochu Feed Mills Co., Ltd.).

0.1% Glycine addition feed: a complete vegetable compound feed prepared by adding glycine to “Itochu Layer 18SU” (a product manufactured on July, 1999 by Itochu Feed Mills Co., Ltd.) in an amount of 0.1% by weight.

0.2% Glycine addition feed: a complete vegetable compound feed prepared by adding glycine to “Itochu Layer 18SU” (a product manufactured on July, 1999 by Itochu Feed Mills Co., Ltd.) in an amount of 0.2% by weight.

Complete vegetable compound feed: negative control “Itochu Layer 18SU” (a product manufactured on July, 1999 by Moji Plant of Itochu Feed Mills Co., Ltd.)

TABLE 4

| | | | | | | | Conventional | |
|---|---|---|---|---|---|---|---|---|
| | Conventional | | | | | | Example 2 | |
| | Example 1 | | Example 2 | | Example 3 | | (Complete | |
| | (Animal Pro- | | (0.1% Glycine | | (0.2% Glycine | | Vegetable | |
| | tein Feed) | | Addition Feed) | | Addition Feed) | | Feed) | |
| ME | 2920 | kcal/ | 2950 | kcal/ | 2950 | kcal/ | 2950 | kcal/ |
| | | kg | | kg | | kg | | kg |
| CP | 19.3% | | 19.3% | | 19.3% | | 19.3% | |

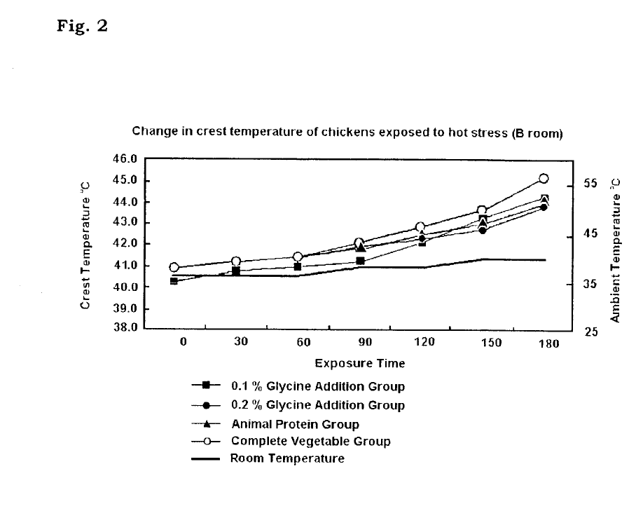

The test results are shown in table 5, FIGS. 2, 3 and 4.

TABLE 5

| | | Conventional | Example 1 | Example 2 | Conventional |
|---|---|---|---|---|---|
| | | Example 1 | (0.1% | (0.2% | Example 2 |
| | | (Animal Protein | Glycine Addition | Glycine Addition | (Complete Vegetable |
| Feeding Result | | Group) | Group) | Group) | Group) |
| Feed Intake | \mathring{1} | 108 ± 11 | 97 ± 15 | 95 ± 14 | 101 ± 8 |
| (g/day/bird) | \mathring{2} | 103 ± 6 | 96 ± 23 | 98 ± 10 | 100 ± 19 |
| | Average | 107 ± 9 | 99 ± 17 | 98 ± 9 | 103 ± 13 |
| Calorie Intake | | 312.4 | 292.1 | 289.1 | 303.9 |
| (kcal/day) | | | | | |
| Water | \mathring{1} | 345 ± 36 | 294 ± 77 | 310 ± 50 | 370 ± 104 |
| consumed | \mathring{2} | 318 ± 35 | 268 ± 89 | 289 ± 48 | 339 ± 49 |
| (ml/day/bird) | Average | 325 ± 37 | 275 ± 83 | 294 ± 48 | 349 ± 74 |

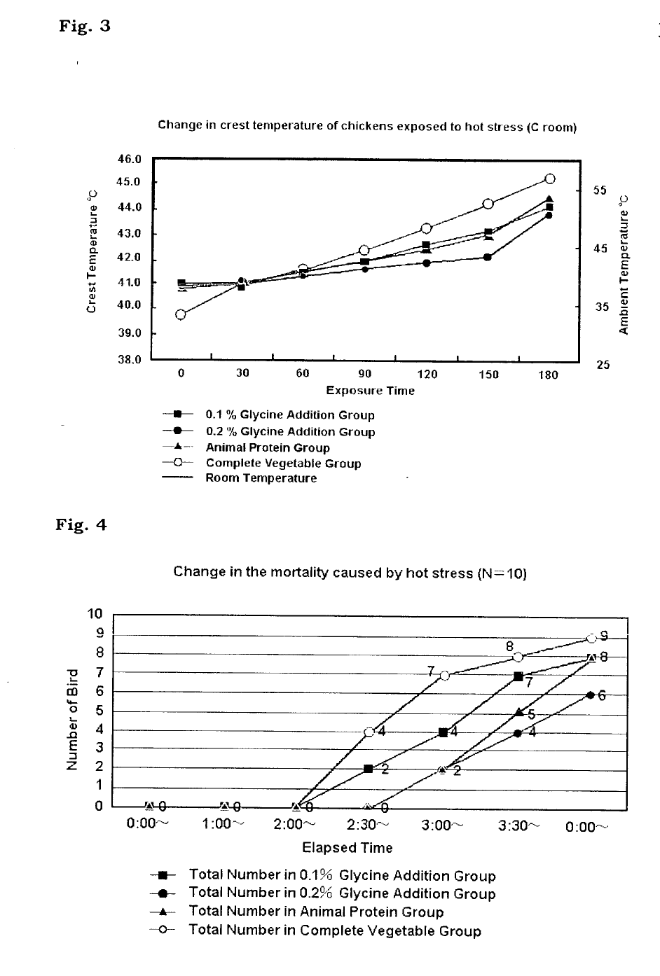

As can be seen from FIGS. 2 and 3 indicating the change in the crest temperature of chickens exposed to hot stress, the crest temperature of the complete vegetable group in both B and C rooms is always appreciably higher than that of any other groups, and particularly the change is remarkable as the temperature increases. The crest temperature of the glycine addition group in both B and C rooms indicates equal trend to that in the animal protein group. Thus, the addition of glycine to the complete vegetable compound feed causes an effect to suppress the elevation in the crest temperature. FIG. 4 indicating the occurrence status of mortality caused due to hot stress also supports this. Also, the occurrence status of mortality may be varied depending on the amount added of glycine.

The amount of feed intake for both the glycine addition groups is slightly less as compared with that for the animal protein group. But in comparison of the absolute value with before test, the amount of feed intake in the animal protein group was greater than any of the glycine addition groups.

The amount of water consumed for the complete vegetable group and 0.2% glycine addition group shows high trend, and the difference in water consumed as compared with the animal protein group was 24 ml.

As to the crest temperature of chickens exposed to hot stress, the complete vegetable group keeps higher crest temperature in comparison with the animal protein group. Contrary thereto, the crest temperature of the glycine addition groups is suppressed to the equal level to or less than that of the animal protein group, thus the effect of suppressing body temperature was recognized in the glycine addition groups.

Since the effect may be significantly recognized in group where the amount added of glycine is larger, it was suggested that addition of glycine to the complete vegetable compound feed causes an effect to mitigate hot stress.

### Effect of the Invention

According to the present invention, when glycine-enriched vegetable compound feed is fed to a layer chicken in the summer season the morality caused by hot stress may be suppressed to the equal level to or less than that attained by the animal protein group.

1. A glycine-enriched vegetable compound feed for a layer chicken which comprises incorporated glycine into a vegetable compound feed in the range of 0.05-0.5% by weight based on the feed.

2. A method for feeding a layer chicken which comprises feeding the layer chicken in the summer season with the glycine-enriched vegetable compound feed as claimed in claim 1, thereby suppressing the morality caused by hot stress.
